(19) United States
(12) Patent Application Publication
(10) Pub. No.: US 2010/0007129 A1
(43) Pub. Date: Jan. 14, 2010

(54) Vestine motif unique bookmarks

(75) Inventor: LaTheasa Vestine Stevens, Austin, TX (US)

Correspondence Address: LaTheasa Vestine Stevens, 14505 Rumfeldt, Austin, TX, 78725, US

(73) Assignee: LaTheasa Vestine Stevens, Austin, TX (US)

(21) Appl. No.: 12/009,287

(22) Filed: Mar. 11, 2008

(51) Int. Cl. B42D 9/00

(52) U.S. Cl. 281/42

(57) ABSTRACT

The adjustable bookmark is an original hand-crafted design that attaches to any size hard cover and paperback book. The bookmark design is unique as to how it securely fits and adjusts around books. This bookmark design consists of a minimum of three ribbons to fit between multiple pages of a book. This unique design allows for various styles, colors, and themes which appeals to its user.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

I first designed this bookmark in the summer of 2007 while working on different styles of beads. This unique bookmark serves to any able bodied person who can read at any level. It was designed to securely attach and adjust to any size paperback or hard cover book. This bookmark design also consists of multiple page holders which allow the user to reduce the damage to books by folding its pages in order to keep its place or placing loose articles between pages that can easily fall out. This hand-crafted bookmark design allows for multiple variations of colors, styles, themes and sizes that can be styled at the user's discretion.

### BRIEF SUMMARY OF THE INVENTION

This unique bookmark design was invented to help reduce problems that exist with the current bookmarks plus it adds a variety of style and color for the bookmark user. One advantage is the elastic cord that attaches to any paperback or hardcover book which keeps the user's bookmark from falling off the book. The second advantage is that the elastic cord has adjustable knots which allow the user the option of sizing the cord to fit small or large books. The third benefit is the multiple ribbons which allow the user to reference more pages. Each bookmark is hand-crafted to allow a large variety of styles, colors, and themes to be used and personalized for its user.

### DESCRIPTION OF THE DESIGN

I have invented a new design for adjustable, beaded bookmarks as set forth in the following specification:

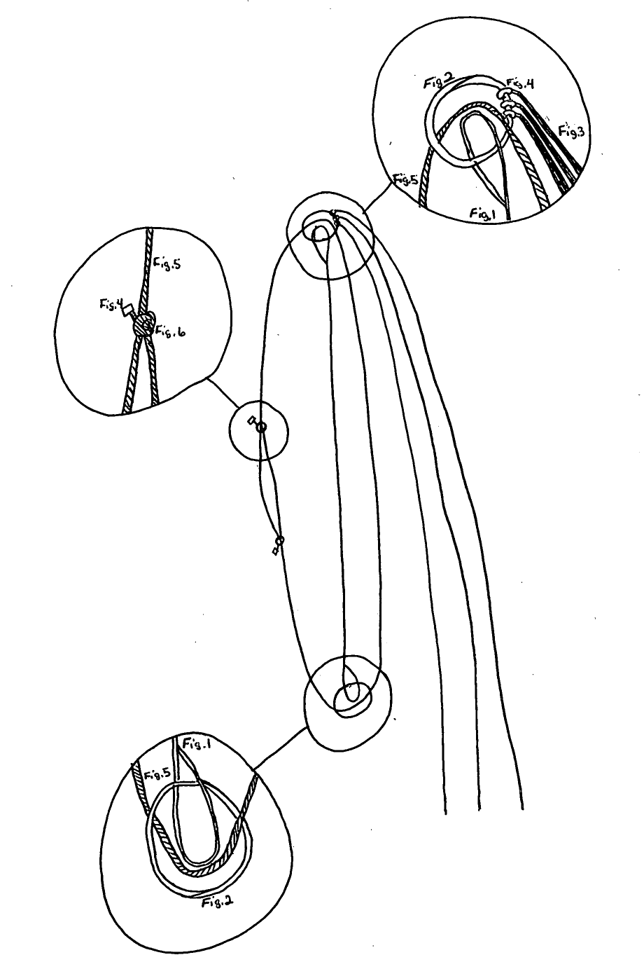

FIG. 1 is a firm, thin metal rod. This rod is curved at each end to hold various beads in place.

FIG. 2 are double rings. The double rings are used to securely attach FIG. 4 and FIG. 5 to FIG. 1.

FIG. 3 are ribbon strips. The ribbon strips are used to distinguish the top of the design. The ribbon strips are shaded in the drawing to indicate color to the ribbons. They serve as place holders in books.

FIG. 4 are crimps. These crimps are used to attach FIG. 2, FIG. 3, and secures the ends of FIG. 5.

FIG. 5 is an elastic cord. The elastic cord goes through the top and bottom double rings (FIG. 2).

FIG. 6 are slip knots. These slip knots allow users to adjust the size of FIG. 5 to support a secure fit around books.

### DETAILED DESCRIPTION OF THE INVENTION

The making of each Vestine Motif Unique Bookmarks begin with having all the tools and equipment which can be purchased at any craft store. The tools consist of a bent-nose plier, a flat-nose plier, a round-nose plier, and a side-cutter plier. The equipment to prepare one bookmark consists of a 7 inch long firm thin metal rod (FIG. 1), two double-rings (FIG. 2), at least three 9 inch long strips of ribbon (FIG. 3), five crimps (FIG. 4) (three for each ribbon and two for the cord ends), and a 20 inch long elastic cord (FIG. 5). You'll also need an assortment of beads and charms (that will go on the metal rod (FIG. 1). The first process is to get the metal rod (FIG. 1) and use the round-nose pliers to form a small loop on one end of the metal rod. Slide one double-ring (FIG. 2) in the loop before completely closing. Now slide on the assortment of beads to FIG. 1 leaving about ½″ rod. Use the round-nose pliers to form a loop to close in the bead arrangement. Slide the second double-ring (FIG. 2) in the loop before completely closing. The next process is to attach one end of a ribbon piece to the clamp end of the crimp (FIG. 4) by using the flat-nose pliers to seal tightly. Slide the circular end of the crimp (FIG. 4) onto one of the double-rings (FIG. 2) which is attached to metal rod (FIG. 1) using the bent-nose pliers. This is now considered the top of the bookmark. Repeat this process until three or more ribbons are attached to the metal rod. The next process is to pull the elastic cord (FIG. 5) through the bottom double-ring and then follow through to the top double-ring. Both ends of the elastic cord are open to the left of the design creating a top and bottom cord end. The next process is to form the slip-knots (FIG. 6). Take the bottom end cord and line it up against the body of the top cord. Wrap the bottom cord end around the front of the top cord and back around. A loop has been formed around both cords. Push the same cord end through the front of the loop and pull through tightly. There will be about one inch of the cord end protruding from this first slip knot. Turn the entire bookmark upside down in preparation to form the second slip knot. Take the open end cord and line it up against the body of the top cord. Wrap the loose cord end around the front of the top cord and back around. A loop has been formed around both cords. Push the same cord end through the front of the loop and pull through tightly.

There will be about one inch of the cord end protruding from this second slip knot. The final steps in creating the Vestine Motif Unique Bookmarks is attaching the last two crimps (FIG. 4) to the protruding cord ends which will keep the slip knots from coming apart. The clamp end is attached tightly to the cord end by using the flat-nose pliers. The circular end of the crimp (FIG. 4) and the remaining cord ends are both cut off using the cutting pliers. The bookmark design is complete (skeletal design).

This bookmark can be placed on any sized hardcover or paperback book. The first step to attaching my bookmark is to open the front cover of the book. Then slide the book cover through the bookmark where only the elastic cords are inside the book where as the bookmark style (beads) and ribbons are on the outside of the book. The ribbons represent the top of the bookmark. For hardcover books move the cord with the slip knots to the inside of the back book cover. For paperback books move both cords to the center page of the book. To adjust the sizes of the bookmark for a secure fit around any small or large book proceed with the following steps. For small books firmly hold one slip knot and with the opposite hand pull on one of the inside cords; alternate sides. (The inside cords are those located between the slip knots.) The slip knots will be propelled away causing the elastic cord to be shortened. For larger books firmly hold one slip knot and with the opposite hand pull on the outside cord which is next to the slip knot you are holding; alternate sides. (The outside cords are those located outside the slip knots.) The slip knots will come together causing the elastic cord to increase.

1. The hand-crafted adjustable bookmark design attaches and adjusts to any size book is an original idea that was created and designed; which uses the same design with various bead styles and color schemes.
